(19) United States
(12) Patent Application Publication
(10) Pub. No.: US 2021/0323284 A1
(43) Pub. Date: Oct. 21, 2021

(54) DISPLAY DEVICE

(71) Applicant: E Ink Holdings Inc., Hsinchu (TW)

(72) Inventor: Chia-I LIU, HSINCHU (TW)

(21) Appl. No.: 17/123,138

(22) Filed: Dec. 16, 2020

(30) Foreign Application Priority Data
Apr. 16, 2020 (TW) 109112772

(51) Int. Cl. B32B 27/06; B32B 27/36; B32B 27/40; B32B 27/32; B32B 27/28

(52) U.S. Cl. CPC B32B 27/06; B32B 27/36; B32B 27/40; B32B 2307/536; B32B 27/281; B32B 2255/26; B32B 2457/20; B32B 27/325

(57) ABSTRACT

A display device includes an optical thin film, a display panel and a coating layer. The display panel is located below the optical thin film. The coating layer is located between the optical thin film and the display panel. The coating layer is located between the optical thin film and the display panel, and the coating layer has a Shear Loss Modules G″ in a range of 10 Pa to 1000 Pa and a Shear Storage Modulus G′ in a range of 100 Pa to 10000 Pa.

### CROSS-REFERENCE TO RELATED APPLICATION

This application claims priority to Taiwan Application Serial Number 109112772, filed Apr. 16, 2020, which is herein incorporated by reference in its entirety.

### BACKGROUND

### Field of Invention

The present invention relates to a display device.

An optical thin film and a display panel of a flexible display device nowadays are attached by the optical clear adhesive. In such condition, the surface hardness of the optical thin film is not enough to resist dragging and tapping when the optical thin film is used as a material to protect the surface of a display device. However, if the hard coating layer is formed on the surface of the optical thin film to increase the surface hardness, the display device may be difficult to be bent with a small angle and the optical clear adhesive may be peeled off during the bending process. In other words, flexible ability and the high surface hardness are conflict properties for a flexible display device.

However, if the optical clear adhesive and the hard coating layer are respectively disposed on the opposite surfaces of the optical thin film without considering the bending ability, the number of the interfaces is increased and the stress due to bending is also creased such that the possibility for peeling off may be increased.

Accordingly, it is still a development direction for the industry to provide a flexible display device to solve the problems described above.

### SUMMARY

The invention provides a display device.

In some embodiments, the display device includes an optical thin film, a display panel and a coating layer. The display panel is located below the optical thin film. The coating layer is located between the optical thin film and the display panel.

In some embodiments, the coating layer is directly in contact with a surface of the optical thin film facing the display panel.

In some embodiments, the coating layer has a Shear Loss Modules (G″) in a range of 10 Pa to 1000 Pa and a Shear Storage Modulus (G′) in a range of 100 Pa to 10000 Pa.

In some embodiments, a surface of the optical thin film facing away from the coating layer has a hardness greater than or equal to pencil hardness 5H.

In some embodiments, the coating layer has a thickness in a range of 5 micrometers to 80 micrometers.

In some embodiments, a material of the coating layer includes acrylic resin.

In some embodiments, the display panel is flexible.

In some embodiments, there is no adhesive material between the coating layer and the optical thin film.

In some embodiments, the display device of claim 1 further includes a functional module located between the coating layer and the display panel.

In some embodiments, the coating layer is directly in contact with a surface of the functional module facing the optical thin film.

In the aforementioned embodiments, since the coating layer has both low Shear Loss Modulus G″ and low Shear Storage Modulus G′, the display device may have high surface hardness, be flexible, and have bending resistance. In addition, the coating layer may have the adhesive property like the optical clear adhesive. Therefore, by disposing the coating layer below the optical thin film, the number of the interfaces of the entire display device may be reduced (or maintained). With such design, the bending stress of the display device may be reduced so as to prevent peeling off or broken phenomena during the bending process due to the increased number of interfaces.

### BRIEF DESCRIPTION OF THE DRAWINGS

The invention can be more fully understood by reading the following detailed description of the embodiment, with reference made to the accompanying drawings as follows:

FIG. 1 is a cross sectional view of a display device according to one embodiment of the present disclosure;

FIG. 2 is a comparison data of rheological property and mechanical property of a display device according to one embodiment of the present disclosure and a conventional display device; and

FIG. 3 is a comparison data of stylus test of a display device according to one embodiment of the present disclosure and a conventional display device.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

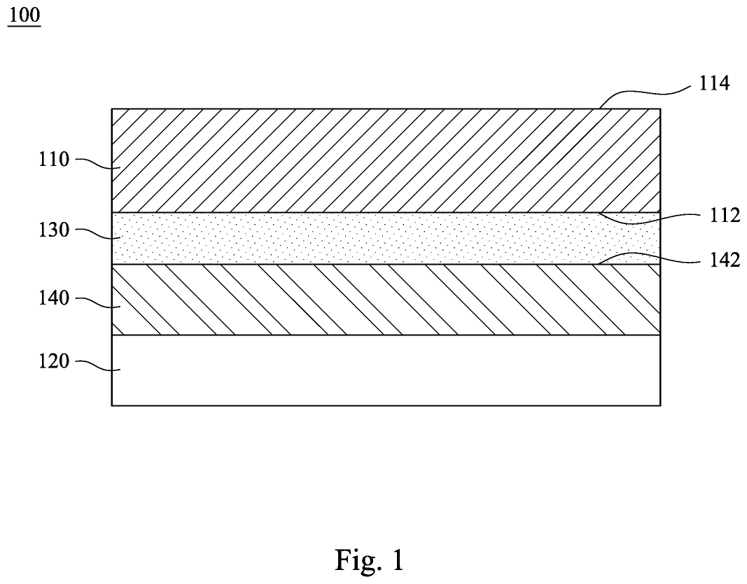

FIG. 1 is a cross sectional view of a display device 100 according to one embodiment of the present disclosure. The display device 100 includes an optical thin film 110, a display panel 120 and a coating layer 130. The display panel 120 is located below the optical thin film 110. The coating layer 130 is located between the optical thin film 110 and the display panel 120, and the coating layer 130 has a Shear Loss Modules G″ in a range of 10 Pa to 1000 Pa and a Shear Storage Modulus G′ in a range of 100 Pa to 10000 Pa. Specifically, the Shear Loss Modules G″ and the Shear Storage Modulus G′ are parameters after curing the coating layer 130. The curing method of the coating layer 130 includes thermal cure or UV cure.

The display device 100 is a flexible display device, and the display panel 120 is flexible. The optical thin film 110 has a surface 112 facing the coating layer 130 and a surface 114 facing away from the coating layer 130. The optical thin film 110 described above is a thin optical film. In order to be employed in the flexible device, the optical thin film 110 has a thickness smaller than 100 micrometers, high transparent property, and bending resistance. For example, a material of the optical thin film 110 may include Poly ester, Poly urethane, Cyclo olefin polymer, Polyimide, or colorless Polyimide (CPI). In the present embodiment, a material of the coating layer 130 may include acrylic resin and functional groups that may bond the coating layer 130 and the surface 112 of the optical thin film 110. In other words, the coating layer 130 is directly in contact with the surface 112 of the optical thin film 110. In another embodiment, the display device 100 further includes a functional module 140. The functional module 140, for example, may be a touch module. In the present embodiment, the coating layer 130 is located between the optical thin film 110 and the functional module 140.

However, for a conventional flexible display device, the optical thin film 110 formed by those materials describe above is attached with a display panel through an optical clear adhesive, and there is no coating layer 130 of the present embodiment. In such condition, although the optical thin film 110 has high transparent, the surface hardness of the optical thin film 110 is not enough to resist dragging and tapping when the optical thin film 110 is used as a material to protect the surface of a display device. Therefore, the conventional flexible display device can not satisfy the requirement of a display device accompanied with stylus.

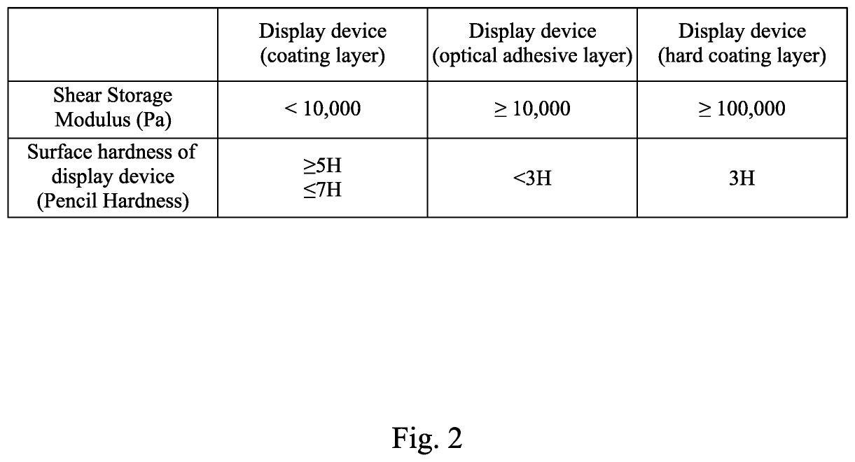

Reference is made to FIG. 1 and FIG. 2. FIG. 2 is a comparison data of rheological property and mechanical property of a display device 100 according to one embodiment of the present disclosure and a conventional display device. The second column in FIG. 2 corresponds to the display device 100 of the present disclosure. That is, the embodiment of which the coating layer 130 is disposed on the surface 112 of the optical thin film 110. The data in the second column includes the Shear Storage Modulus G′ of the coating layer 130 and the hardness of the surface 114 of the optical thin film 110 of the display device 100. The third column in FIG. 2 corresponds to a display device that a conventional optical clear adhesive is disposed on the surface 112 of the optical thin film 110. The data in the third column includes the Shear Storage Modulus G′ of the optical clear adhesive and the hardness of the surface 114 of the optical thin film 110. The fourth column in FIG. 2 corresponds to a display device that a conventional hard coating layer is disposed on the surface 114 of the optical thin film 110. The data in the fourth column includes the Shear Storage Modulus G′ of the hard coating layer and the hardness of a surface 114 of the hard coating layer facing away from the optical thin film 110 (that is the outermost surface of the display device).

The hardness of the surface of the display device 100 facing away from the coating layer 130 is greater than or equal to the pencil hardness 5H. As shown in FIG. 2, the hardness of the surface 114 of the optical thin film 110 of the display device 100, for example, may be greater than or equal to pencil hardness 5H and is smaller than or equal to pencil hardness 7H, while the hardness of the surface of the conventional display device is smaller than or equal to pencil hardness 3H. Reason for this difference is that the coating layer 130 after curing has a lower Shear Loss Modulus G″, which means that the energy consumed by the viscosity part of the coating layer 130 after curing is lower. That is, an unrecoverable deformation of the coating layer 130 after curing due to vibration will occur less easily. In contrary, the conventional optical clear adhesive lacks the property to recover quickly after being crashed.

Accordingly, by disposing the coating layer 130 on the surface 112 of the optical thin film 110, the surface 114 that is at the outermost side of the optical thin film 110 may absorb impact more efficiently. That is, when the surface 114 suffers the vibration force or impact (e.g., tapping test), the surface 114 may disperse the impact with high loading. As such, the surface 114 of the optical thin film 110 may recover quickly after tapping test, and there is no dent or deformation formed on the surface 114. Therefore, by disposing the coating layer 130 with low Shear Loss Modulus G″ on the surface 112 of the optical thin film 110, the hardness of the surface 114 of the optical thin film 110 facing away from the coating layer 130 may be increased and is greater than or equal to pencil hardness 5H and smaller than or equal to pencil hardness 7H. As such, the surface 114 of the optical thin film 110 may has great protection ability so as to be employed in a flexible display device accompanied with stylus.

In a flexible display device, the display device will be difficult to be bent if a hard coating layer is formed on the surface 114 of the optical thin film 110 so as to increase the surface hardness. In other words, flexibility and the high surface hardness are conflict properties. As shown in FIG. 2, the Shear Storage Modulus G′ of the coating layer 130 of the present embodiment is smaller than 10000 Pa, the Shear Storage Modulus G′ of the conventional optical clear adhesive may, for example, be greater than 10000 Pa, and the Shear Storage Modulus G′ of the conventional hard coating layer may, for example, be greater than 100000 Pa. Accordingly, the Shear Storage Modulus G′ of the coating layer 130 is smaller than that of the conventional optical clear adhesive and the conventional hard coating layer, which means that the elastic part of the coating layer 130 after curing stores less energy. That is, the coating layer 130 after curing is easier to be bent. Therefore, the coating layer 130 has better flexibility and bending resistance than the optical clear adhesive.

As described above, since the coating layer 130 has both low Shear Loss Modulus G″ and low Shear Storage Modulus G′, the display device 100 may have high surface hardness (that is the surface 114 of the optical thin film 110), be flexible, and have bending resistance.

Specifically, regarding the requirements of cutting the optical clear adhesive layer, the low Shear Storage Modulus G′ (smaller than 10000 Pa) of the optical clear adhesive makes it difficult to fracture the optical clear adhesive due to after tack, and the optical clear adhesive layer may be deformed when the adhesive is dragged during the cutting process. Therefore, the Shear Storage Modulus G′ of the conventional optical clear adhesive will be designed as greater than or equal to 10000 Pa. In contrary, regarding the display device 100 of the present embodiment, since the coating layer 130 is coated on the surface 112 of the optical thin film 110, and then the coating layer 130 is cured so as to be cut. After the hardness of the surface 114 of the optical thin film 110 is enhanced, the cutting process will be easier. As such, fabrication process of the display device 100 will be more flexible and convenient.

Reference is made to FIG. 1, the display device 100 further includes a functional module 140 located between the coating layer 130 and the display panel 120. The functional module 140 may be touch module or writing module, but the present disclosure is not limited in this regard. In the present embodiment, the coating layer 130 is directly in contact with the surface 142 of the functional module 140 facing the optical thin film 110. The coating layer 130 is viscous. Therefore, there can be no adhesive material between the coating layer 130 and the functional module 140, and there can be no adhesive material between the coating layer 130 and the optical thin film. In other words, the functional module 140 is attached with the optical thin film 110 through the coating layer 130. That is, the coating layer 130 can not only replace the conventional optical clear adhesive that is used to attached the optical thin film 110 and the functional module 140 but also has better flexibility and bending resistance.

For a conventional flexible display device, if the optical clear adhesive layer and the hard coating layer are disposed on the surface 112 and the surface 114 of the optical thin film 110 when the bending ability is not concerned, a number of the interface is increased such that the risk of peeling off is increased due to the increased bending stress. In the present embodiment, the optical thin film 110 is located at the outermost side of the display device. In other words, there is no need to dispose other protection material such as the hard coating layer on the surface 114 of the optical thin film 110. That is, the coating layer 130 may have the adhesion ability of the optical clear adhesive layer and may provide the protection ability for the surface 114 of the optical thin film 110. Therefore, by disposing the coating layer 130 on the surface 112 of the optical thin film 110, the number of the interfaces of the entire display device 100 may be reduced (or maintained). With such design, the bending stress of the display device 100 may be reduced so as to prevent the peeling off or broken phenomena during the bending process due to the increased number of interfaces.

In addition, when considering the factors such as bending radius and stress distribution of the flexible display device, thin optical film is commonly employed (for example, thickness is smaller than 100 micrometers). However, thickness of the optical thin film 110 is still necessary to be considered when disposing the coating layer 130, such that the display device 100 may has bending resistance and high surface hardness. In other words, since the coating layer 130 may be directly disposed on the conventional optical thin film 110, the application range of the optical thin film 110 may be wider.

In the present embodiment, the coating layer 130 has a thickness in a range of 5 micrometers to 80 micrometers. The thickness of the optical clear adhesive of the flexible display device, for example, is in a range of 25 micrometers to 50 micrometers. If the thickness of the optical clear adhesive is reduced so as to increase the bending ability of the display device, the viscosity of the optical clear adhesive may be degraded such that the peeling off phenomena of the display device may occur. In comparison, since the coating layer 130 has better flexibility and bending resistance, there is no low viscosity and peeling off problems and the attaching stability may be guaranteed. In addition, since the thickness of the coating layer 130 is similar to or thinner than the thickness of the optical clear adhesive layer, the coating layer 130 may replace the optical clear adhesive without increasing the thickness of the display device 100. Therefore, the bending ability of the display device 100 will not be reduced.

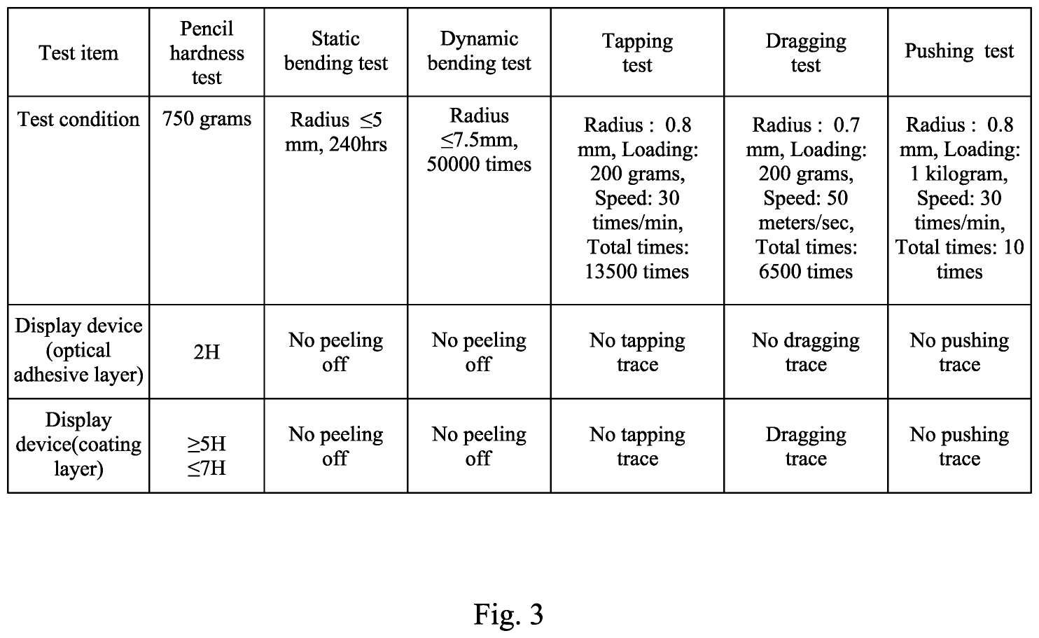

FIG. 3 is a comparison data of stylus test of a display device 100 according to one embodiment of the present disclosure and a conventional display device. FIG. 3 is a comparison between the display device 100 shown in FIG. 1 and a display device of which the optical thin film 110 is attached with the functional module 140 through optical clear adhesive. The display device 100 shown in FIG. 3 and the conventional display device each has an optical thin film 110 that has a thickness of 80 micrometers, a functional module 140 that has a thickness of 50 micrometers, and a display device 120 that has a thickness of 80 micrometers. A coating layer 130 that has a thickness of 25 micrometers and an optical clear adhesive layer that has a thickness of 25 micrometers are demonstrated herein as an example for comparison.

As shown in the data of the second column in FIG. 3, in a pencil hardness test with 750 grams loading, the conventional display device has pencil hardness 2H, while the display device 100 of the present embodiment has pencil hardness greater than or equal to 5H and smaller than or equal to 7H. As described above, since the coating layer 130 has low Shear Loss Modulus G″, the surface 114 of the optical thin film 110 facing away from the coating layer 130 has a better protection ability than the hard coating layer.

As shown in the data of the third and fourth columns in FIG. 3, in a static folding test, the conventional display device and the display device 100 have no peeling off phenomena after being bent with a radius smaller than or equal to 5 micrometers for 240 hours. In a dynamic folding test, the conventional display device and the display device 100 have no peeling off after being bent fifty thousand times with a radius smaller than or equal to 7.5 micrometers. In other words, since the coating layer 130 of the display device 100 has low Shear Storage Modulus G′, the coating layer 130 may not only have advantages such as flexible and bending resistant but also have similar adhesive property like the optical clear adhesive of the conventional display device.

As shown in the data of the fifth column in FIG. 3, in a tapping test with a pencil, the test is performed with a pencil tip having a radius smaller than or equal to 0.8 micrometers. The test conditions include loading with 200 grams, tapping velocity of 30 times per minute, and tapping number of 13500. With above test conditions, the conventional display device and the display device 100 have no dent.

As shown in the data of the sixth column in FIG. 3, in a pencil dragging test, the test is performed with a pencil tip having a radius smaller than or equal to 0.7 micrometers. The test conditions include 200 grams loading, dragging velocity of 50 micrometers per second, and dragging number of 6500. With above test conditions, the conventional has writing trace due to the dragging of pencil tip, while the display device 100 has no writing trace due to the dragging of pencil tip.

As shown in the data of the seventh column in FIG. 3, in a pencil pushing test, the test is performed with a pencil tip having a radius smaller than or equal to 0.8 micrometers. The test conditions include one kilogram loading, pushing velocity of 30 micrometers per second, and pushing number of 10. With above test conditions, the conventional display device and the display device 100 have no pushing trace.

As shown in the data of the fifth column and the seventh column above, since the display device 100 has low Shear Loss Modulus G″, the display device 100 may recover quickly with no dent formed thereon. Comparing to the conventional display device of which the optical thin film 110 is attached to the functional module 140 through the optical clear adhesive, the surface hardness (that is, the surface 114 of the optical thin film) of the display device may satisfy the requirement of a display device accompanied with stylus.

In summary, since the coating layer 130 has both the low Shear Loss Modulus G″ and low Shear Storage Modulus G′, the display device 100 may have high surface hardness (that is the surface 114 of the optical thin film 110), be flexible, and have bending resistance. In addition, the coating layer 130 may has the adhesive property like the optical clear adhesive. Therefore, by disposing the coating layer 130 on the surface 112 of the optical thin film 110, the number of the interfaces of the entire display device 100 may be reduced (or maintained). With such design, the bending stress of the display device 100 may be reduced so as to prevent the peeling off or broken phenomena during the bending process due to the increased number of interfaces.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device, comprising:
an optical thin film;
a display panel located below the optical thin film; and
a coating layer located between the optical thin film and the display panel.

2. The display device of claim 1, wherein the coating layer is directly in contact with a surface of the optical thin film facing the display panel.

3. The display device of claim 1, wherein the coating layer has a Shear Loss Modules (G″) in a range of 10 Pa to 1000 Pa and a Shear Storage Modulus (G′) in a range of 100 Pa to 10000 Pa.

4. The display device of claim 1, wherein a surface of the optical thin film facing away from the coating layer has a hardness greater than or equal to pencil hardness 5H.

5. The display device of claim 1, wherein the coating layer has a thickness in a range of 5 micrometers to 80 micrometers.

6. The display device of claim 1, wherein a material of the coating layer includes acrylic resin.

7. The display device of claim 1, wherein the display panel is flexible.

8. The display device of claim 1, wherein there is no adhesive material between the coating layer and the optical thin film.

9. The display device of claim 1, further comprising:
a functional module located between the coating layer and the display panel.

10. The display device of claim 1, wherein the coating layer is directly in contact with a surface of the functional module facing the optical thin film.
